(19) United States
(12) Patent Application Publication
(10) Pub. No.: US 2017/0334779 A1
(43) Pub. Date: Nov. 23, 2017

(54) PUMPABLE GEOPOLYMER COMPOSITION FOR WELL SEALING APPLICATIONS

(71) Applicant: The Catholic University of America, Washington, DC (US)

(72) Inventors: Weiliang GONG, Rockville, MD (US); Hui XU, Rockville, MD (US); Werner LUTZE, Chevy Chase, MD (US); Ian PEGG, Alexandria, VA (US)

(21) Appl. No.: 15/597,227

(22) Filed: May 17, 2017

Related U.S. Application Data
(60) Provisional application No. 62/339,334, filed on May 20, 2016.

(51) Int. Cl. C04B 28/00; C04B 22/08; C04B 24/26; C09K 8/42; E21B 33/14; C04B 22/06; C04B 14/22; C04B 103/22; C04B 103/12; C04B 103/32; C04B 111/00

(52) U.S. Cl. CPC C04B 28/006; C04B 22/062; C04B 22/08; C04B 24/26; C09K 8/42; C04B 14/22; E21B 33/14; C04B 2103/12; C04B 2103/32; C04B 2111/00146; C04B 2103/22

(57) ABSTRACT

Three pumpable geopolymer compositions for well sealing application is disclosed herein. One pumpable geopolymer composition comprises: (i) less reactive aluminosilicate; (ii) more reactive aluminosilicate; (iii) alkaline silicate activator solution with a very low SiO₂/M₂O. Another pumpable geopolymer composition comprises: (i) less reactive aluminosilicate; (ii) more reactive aluminosilicate; (iii) alkaline silicate-free activator solution that may contain an alkali salt; and (iv) powdered alkali silicate glass. The third pumpable geopolymer composition comprises (i) less reactive aluminosilicate; (ii) more reactive aluminosilicate; (iii) alkaline low silicate activator solution; and (iv) powdered alkali silicate glass.

### CROSS-REFERENCE TO RELATED APPLICATIONS

This application claims benefit of priority of U.S. Provisional Patent Application No. 62/339,334, entitled “PUMPABLE GEOPOLYMER COMPOSITION FOR WELL SEALING APPLICATIONS,” filed May 20, 2016, the entire content and disclosure of which is incorporated herein by reference in its entirety.

This application makes reference to U.S. patent application Ser. No. 14/193,001 to Gong, et al., entitled, “HIGH-STRENGTH GEOPOLYMER COMPOSITE CELLULAR CONCRETE,” filed Feb. 28, 2014, the entire content and disclosure of which is incorporated herein by reference in its entirety.

### BACKGROUND

### Field of the Invention

The present invention relates to geopolymer compositions or slurries. More specifically, the present invention is directed to utilization of pumpable geopolymer compositions or slurries for well cementing applications in oil and/or gas industries.

### Background of the Invention

Improper oil and gas well design and well cementing can jeopardize oil or gas production. Oil spills such as the recent Gulf of Mexico deep-water horizon oil spill are some of the causes of oil loss from the global reserve and of environmental disasters. The combustion and calcination of fossil fuels emits greenhouse gases and carbon dioxide (CO₂) poses the adverse effect to the environment as it contributes to 55% of the global warming. Carbon capture and storage (CCS) is one of the feasible solutions and the captured CO₂ is injected through borehole wells in CCS. In both the cases, cementitious materials are used as the primary sealant in injection wells. Well cementing is the process of placing cementitious slurry in the annulus space between the well casing and the geological formations surrounding the well bore in order to provide zonal isolation in oil, gas, water, water wells and well as injection well for CCS. The goal is to exclude fluids such as water or gas to move from one zone to another zone in the well.

In oil and gas industries, Portland cement Type G has been used as the primary sealant material with different additives. Generally, Portland cement slurry is placed at densities about 2.0 MT/m³ but such low densities will lead to significant shrinkage of the hardened material. The consequences of shrinkage are non-trivial. In North America, there are literally tens of thousands of abandoned, inactive, or active oil and gas wells, including gas storage wells, that currently leak gas to surface. Some of the gas enters shallow aquifers and contaminates groundwaters. In addition, Portland cement based cementing materials are unstable in CO₂ rich environment as it experiences degradation, shrinkage, strength retrogression, durability concerns, increase in permeability and porosity. In addition, Portland cement based well sealing materials are vulnerable to attack by the salt, acid and H₂S medias that are commonly encountered in the abandoned oil or gas wells.

Cement integrity and durability in the wells are a major concern for oil industries in securing long-term production especially after the Macendo disaster. Recent researches show that several problems are associated with use of Portland cement such as permeability and strength degradation of well cement, susceptibility to chemical reactions, poor durability and leakage. Now the industries are seeking alternative cementitious systems that meet the technical requirements and, at the same time, can contribute toward reducing an overall greenhouse gas footprint.

### SUMMARY

According to a first broad aspect, the present invention provides a pumpable geopolymer composition comprising: a less reactive aluminosilicate; a more reactive aluminosilicate; and an alkaline low-silicate activator solution as carrier fluid.

According to a second broad aspect, the present invention provides a pumpable geopolymer composition comprising: a less reactive aluminosilicate; a more reactive aluminosilicate; an alkaline silicate-free activator solution as carrier fluid; and a powdered alkali silicate glass.

According to a third broad aspect, the present invention provides a pumpable geopolymer composition comprising: a less reactive aluminosilicate; a more reactive aluminosilicate; an alkaline low-silicate activator solution as carrier fluid; and a powdered alkali silicate glass.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 illustrates viscosity as functions of shear rate and water to binder ratio (w/b) for well cementing geopolymer compositions that employ a low SiO₂/M₂O ratio in the alkali activator solution, according to one embodiment of the present invention.

FIG. 2 illustrates viscosity as functions of shear rate and water to binder ratio (w/b) for well cementing geopolymer compositions that employ a powdered soluble alkali silicate glass, according to one embodiment of the present invention.

### DETAILED DESCRIPTION OF THE INVENTION

### Definitions

Where the definition of terms departs from the commonly used meaning of the term, applicant intends to utilize the definitions provided below, unless specifically indicated.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

For purposes of the present invention, the term “comprising”, the term “having”, the term “including,” and variations of these words are intended to be open-ended and mean that there may be additional elements other than the listed elements.

For purposes of the present invention, directional terms such as “top,” “bottom,” “upper,” “lower,” “above,” “below,” “left,” “right,” “horizontal,” “vertical,” “up,” “down,” etc., are used merely for convenience in describing the various embodiments of the present invention. The embodiments of the present invention may be oriented in various ways. For example, the diagrams, apparatuses, etc., shown in the drawing figures may be flipped over, rotated by 90° in any direction, reversed, etc.

For purposes of the present invention, a value or property is “based” on a particular value, property, the satisfaction of a condition, or other factor, if that value is derived by performing a mathematical calculation or logical decision using that value, property or other factor.

For purposes of the present invention, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

For purposes of the present invention, the term “cement” refers to a binder, a substance used in construction that sets, hardens and adheres to other materials, binding them together. Cement is seldom used solely, but is used to bind sand and gravel (aggregate) together. Cement is used with fine aggregate to produce mortar for masonry, or with sand and gravel aggregates to produce concrete. Cements used in construction may be inorganic, lime or calcium silicate based, and can be characterized as being either hydraulic or non-hydraulic, depending upon the ability of the cement to set in the presence of water.

For purposes of the present invention, the term “ground granulated blast furnace slag” refers to a glassy granular material that varies, from a coarse, popcorn-like friable structure greater than 4.75 mm in diameter to dense, sand-size grains. Grinding reduces the particle size to cement fineness, allowing its use as a supplementary cementitious material in Portland cement-based concrete. Typical ground granulated blast furnace slag includes 27-38% SiO₂, 7-12% Al₂O₃, 34-43% CaO, 7-15% MgO, 0.2-1.6% Fe20 3, 0.15-0.76% MnO and 1.0-1.9% by weight. Since BFS is almost 100% glassy (or “amorphous”), it is generally more reactive than most fly ashes. Alkali activation of BFS yields essentially calcium silicate hydrate (CSH) and calcium aluminosilicate (CASH) gels. The Geopolymers made by alkali activation of BFS usually sets and hardens very quickly, resulting in much higher ultimate strength than geopolymers made with low Ca class F fly ash.

For purposes of the present invention, the term “Fly ash” refers to a fine powder byproduct formed from the combustion of coal and comprise mainly of glassy spherical particles, American Society for Testing and Materials (ASTM) C618 standard recognizes two major classes of fly ashes, Class C and Class F. The lower limit of (SiO₂+Al₂O₃+Fe₂O₃) for Class F fly ash is 70% and that for Class C fly ash it is 50%. In general, Class F fly ashes generally have a calcium oxide content of about 15 wt % or less, whereas Class C fly ashes generally have a higher calcium oxide content (e.g., higher than 15 wt %, such as 20 to 40 wt %). low CaO (e.g., <8 wt %) Class F fly ash based geopolymer usually sets and hardens very slowly and has a low final strength when cured at ambient temperatures (e.g., room temperature) and its reactivity increases with increasing curing temperatures as well as increases with increasing alkali-earth oxides (e.g., CaO) it contains. For example, geopolymers made with high Ca Class F fly ash and Class C fly ash set and hardened very quickly due to instant formation of calcium silicate hydrate (CSH) gel. Alkali activation of low CaO Class F fly ash yields mainly alkali aluminosilicate gels (AAS) which in general resembles the zeolitic structure but in the amorphous state.

For purposes of the present invention, the term “geopolymers” refers to inorganic, typically ceramic-like materials that form long-range, covalently bonded, non-crystalline (amorphous) networks. In disclosed embodiments, geopolymers may include silicon and aluminum atoms bonded via oxygen atoms into a polymer network. Geopolymers are prepared by dissolution and poly-condensation reactions between a reactive aluminosilicate material and an alkaline silicate solution, such as a mixture of an alkali metal silicate and metal hydroxide. The process is termed as geopolymerization or more broadly alkali activation. Examples of a reactive aluminosilicate material are Class F fly ash (FFA) and metakaolin (MK) This first stage of the geopolymerization is controlled by the aptitude of the alkaline compound to dissolve the fly ash glass network and to produce small reactive species of silicates and aluminates:

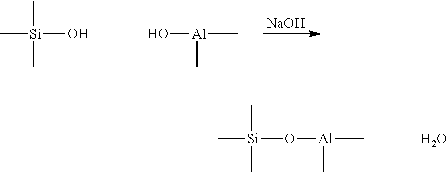

Once dissolved, the species become part of the aqueous phase, i.e., the activating solution, which already contains silicate. A complex mixture of silicate, aluminate and aluminosilicate species is thereby formed. In concentrated solutions this results in the formation of an alkali aluminosilicate gel, as the species in the aqueous phase form large networks by poly-condensation.

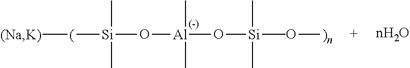

After gelation, the system continues to rearrange and reorganize, as the connectivity of the gel network increases, resulting in a three-dimensional, amphorphous, zeolitic aluminosilicate network.

For purposes of the present invention, the term “geopolymer composition” refers to geopolymer based mixes where reaction of some low-calcium reactive aluminosilicate materials such as Class F fly ahs and metakaolin with an alkaline silicate activator solution yields typically an alkali aluminosilicate gel. The AAS gel usually has an empirical formula that can be presented as Mₙ[-(SiO₂)_{z}—AlO₂]ₙ wH₂O where M represents the alkali cation; z, the molar ratio of Si to Al (1, 2 or 3); and n, the degree of polycondensation. More broadly, the term “geopolymer composition” refer to a class of alkali activated materials (AAM) where alkali activation of high-calcium aluminosilicate materials such as Class C fly ash and blast furnace slag yields mainly CSH and CASH. Further more broadly, the term “geopolymer composition” refer to a class of alkali activated materials (AAM) where alkali activation of composite binder materials consisting of low- and high-calcium aluminosilicate materials such as blast furnace slag, Class F and Class C fly ashes, and metakaolin yields typically hybrid gels of CSH, CASH and AAS.

For purposes of the present invention, the term “pumpable geopolymer composition” refers to geopolymer based mixes are pumpable to allow placing a geopolymer slurry in the annulus space between a well casing and geological formations surrounding a well bore. Typically, a pumpable slurry for well sealing applications should have a viscosity less than or equal to 4 poises or 400 mPa·s (e.g., at a shear rate of 100 s⁻¹).

For purposes of the present invention, the term “pumpable time” refers to a certain period of time when a geopolymer slurry remains fluid while it is pumped into the annulus space between the well casing and the geological formations surrounding the well bore.

For purposes of the present invention, the term “room temperature” refers to a temperature of from about 20° C. to about 25° C.

For purposes of the present invention, the term “slurry” or “slurries” refers to a semi-liquid mixture, e.g., typically of fine particles of cement or cement-like suspended in water or any fluid mixture of a pulverized solid with a liquid (e.g., water or an alkaline silicate solution).

For purposes of the present invention, the term “soluble” refers to a substance capable of being dissolved, especially easily dissolved in some solvent, usually water.

For purposes of the present invention, the term “solubility” refers to a property of a solid, liquid, or gaseous chemical substance called solute to dissolve in a solid, liquid, or gaseous solvent.

### DESCRIPTION

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternatives falling within the spirit and the scope of the invention.

The extensive literature and the prior work conducted by the disclosed invention establish that geopolymers possess much better mechanical and chemical durability (e.g., in acid, base, salt and CO₂-rich medias) than Portland cement based cementitious materials. In addition, geopolymers use mostly industrial waste products, emit much less carbon dioxide during manufacturing and thus they are green and sustainable. Therefore, geopolymer compositions can be ideal well sealing materials for oil or gas industries.

In oil well cementing, a cement slurry is pumped through a steel casing to the bottom of the well and then up through the annulus between the casing and the surrounding rock. The primary purpose of the cementing process is to restrict fluid movement between formations and to bond and support casing. Typically, the injection depth can be more than a few kilometers. The cement slurry hydrates under elevated temperatures and pressures. The temperature may vary up to >140° C. and pressure may go up to 75 MPa of confinement. Pumping can take several hours and retarders and dispersants are widely used to prevent premature hardening. The high temperatures and high pressure make oil well cementing a very challenging task.

The prior art documents disclose mostly the use of geopolymer compositions as building and construction materials. For example, U.S. Pat. No. 4,509,985 discloses an early high-strength mineral polymer manufactured from metakaolin and blast furnace slag. Sufficient hardening for demolding is obtained in just about 1 hour with this composition. U.S. Pat. No. 4,642,137 discloses a binder composition composed up of metakaolin, blast furnace slag, fly ash, dry alkali silicate and alkali hydroxide, and amorphous silica. In junction with Portland cement, curable materials have a high early strength and ultimate strength. US Patent Application No. US2011/0132230 discloses a geopolymer precursor dry mixture composition which comprises metakaolin, amorphous sodium silicate powder and sodium hydroxide. U.S. Pat. No. 7,727,330 and U.S. Pat. No. 8,323,398 disclose geopolymer binder compositions manufactured from Class F fly ash, blast furnace slag and an aqueous chemical activator comprising alkaline carbonate and alkaline silicate for mortar and concrete applications. U.S. Pat. No. 8,202,362 discloses geopolymer cement based on a binary Class F fly ash and blast furnace slag binder with an aqueous alkaline silicate solution in which the ratio of SiO₂:M₂O is great than 1.28 where M=Na or K. US Patent Application No. US2007/0125272 discloses a fly ash/blast furnace slag geopolymer concrete composition in which the ratio of SiO₂:Na₂O is at least 0.9 in the liquid alkaline silicate solution. U.S. Pat. No. 5,366,547 discloses a method to use a phosphate additive to retard the set time of alkali-activated blast furnace slag. U.S. Pat. No. 5,435,843 discloses an alkali activated Class C fly ash composition where a retarder is needed to slow down setting.

Unfortunately, the geopolymer compositions disclosed in the aforementioned prior art documents as construction and building materials cannot be used as a well cementing material in the oil industry. These geopolymer compositions use more reactive aluminosilicate pozzolans, such as metakaolin and blast furnace slag, which require an alkali activator solution with a significantly smaller water to binder ratio (w/b), a high concentration of alkali silicate and a high molar SiO₂/M₂O ratio to manufacture useful construction and building products. Generally, these geopolymers have a rapid set behavior even at ambient temperatures and a retarder is needed to extend set times, particularly when the embient temperatures are high.

At the present, only a few prior art have discussed geopolymers for application in oil or gas industries. U.S. Pat. No. 6,068,055 discloses well sealing compositions based on combination use of blast furnace slag and epoxides. The alkaline activator is a non alkali-silicate one. The compositions will yield an hybrid organic polymer and alkali-activated slag materials and the organic resins are the essential components of the disclosed well sealing compositions. Epoxide does improve shear bonding strength and gas impermeability of the well sealing materials. However, it is well known that alkali-activated blast furnace slag sets and hardens rapidly even at ambient temperatures. Without using an efficient retarder, thickening time may be significantly reduced at temperatures over 140° F. or 60° C., rendering pumping and cementing processes very difficult. In addition, organic molecules are usually unstable when exposed to a high temperature, corrosive environment, which is the case in an oil or gas well bore a few thousand meters deep, which may significantly impact long term performance of well cementing.

U.S. Pat. No. 7,846,250 discloses geopolymer composition intended for use in carbon dioxide storage. The composition is formed from a suspension comprising an aluminosilicate source, a metal silicate, an alkaline activator, and a retarder. The patent used metakaolin and Class F fly ash as examples for aluminosilicate source and in the claims the aluminosilicate sources further include Class C and F fly ashes, blast furnace slag and other materials. However, claim 9 discloses the geopolymer composition is in majority poly sialate-siloxo with molar Si/Al near 2 which is specified in claim 10. It is well known that alkali-activation of class C fly ash and blast furnace slag yields CSH and CASH gels that are fundamentally different from the poly sialate-siloxo geopolymer in structure, chemistry and properties. These aluminosilicate materials used for manufacturing geopolymers are not new and have been disclosed in the prior art and extensively studied in the literature. One property of the disclosed geopolymer compositions is its ability to set rapidly, particularly at elevated temperatures and, therefore, the retarder must be used to control set time of the geopolymer suspension. The retarder is the essential additive for the disclosed geopolymer compositions. Use of retarder will impact performance of the hardened geopolymer materials and ideally no retarder should be applied in favor of desirable performance of well sealing.

U.S. Pat. No. 7,794,537 discloses a similar geopolymer composition to these disclosed in U.S. Pat. No. 7,846,250 but intended for oil field application. Again, retarder is an essential component of the claimed geopolymer composition. While both patents seem fail to disclose a geopolymer composition that is unique from the ones in the prior art and published in the literature, the use of retarder may not be efficient in retarding thickening and setting when cured at elevated temperatures that is the case for the well sealing application. Use of retarder may also yield a hardened geopolymer with significantly reduced performance such as lowered compressive strength and higher permeability. Therefore, no retarder at all should be included if the desirable properties of a geopolymer well sealing materials can be met. (WGL's note: In principal, our patent does not employ a retarder to extend set time. Not part of the draft)

US Patent Application No. US2011/0284223 discloses compositions and methods for well cementing application that employ organic compounds as retarder for geopolymeric systems. The preferred compounds as a retarder include aminated polymer, amine phosphonates, quaternary ammonium compounds and tertiary amines. The geopolymer composition comprises an aluminosilicate source, an activator, a carrier fluid and a retarder. While geopolymer composition itself is not unique, the effect of these retarders on the hardened properties such as compressive strength was not communicated.

US Patent Application No. US2012/0318175 discloses a pumpable geopolymer composition comprising a carbohydrate-based compound as a mixing aid and dispersion agent for oil and/or gas industrial applications. The patent application uses Class C and Class F fly ashes and metakaolin as examples for the aluminosilicate source. Such an organic compound acts like a water reducer and does improve rheological performance of the geopolymer suspension. However, again, the geopolymer compositions disclosed are not unique as compared to the prior art. The thickening times or set times for the geopolymer compositions at elevated temperatures that will be encountered for well sealing applications were not communicated. It is well known in the prior art that Class C fly ash based alkali-activated materials exhibit an extremely rapid setting behavior. Without an efficient retarder, the disclosed compositions may fail for a well sealing project.

Thus, an objective of the present invention is to provide a geopolymer composition that forms a pumpable suspension or slurry with an available pumping time of at least 6 hours at elevated temperatures and that produces a mechanically and chemically durable hardened well cementing material used for the oil and gas industries with using a set retarder admixture.

One embodiment described herein provides geopolymer compositions that can be used in well sealing or well cementing applications in oil and gas industries. A well cementing geopolymer composition comprises: (i) at least one Class F fly ash material having less than or equal to 15 wt % of calcium oxide; (ii) at least one reactive aluminosilicate from the group of blast furnace slag, metakaolin, Class C fly ash, vitreous calcium silicate, and kiln dust; and (iii) an aqueous alkaline silicate activator. The aqueous alkali silicate activator must have a low molar ratio of SiO₂/M₂O where M=Na, K, preferably less than or equal to 0.75. The aqueous alkali silicate activator should have a low molar alkali hydroxide concentration as well, preferably less than 8. The w/b ratio must be large enough to produce a well cementing slurry that is pumpable, preferably from about 0.28 to about 0.50 and more preferably from about 0.35 to about 0.45.

Another embodiment provides a well cementing geopolymer composition including: (i) at least one Class F fly ash material having less than or equal to 15 wt % of calcium oxide; (ii) at least one reactive aluminosilicate from the group of blast furnace slag, metakaolin, Class C fly ash, vitreous calcium silicate, and kiln dust; (iii) an alkaline silicate-free activator solution and (iv) a powdered soluble alkali silicate glass. The molar MOH calculated from the combined silicate-free solution and powdered alkali silicate glass should be less than about 10, and more preferably less than 8, where M represents K, Na. The SiO₂/M₂O ratio calculated from the combined silicate-free solution and powdered alkali silicate glass should be between 0.25 to 1.50 and the w/b ratio should be large enough to produce a well cementing slurry that is pumpable, preferably from about 0.28 to about 0.55 and more preferably from 0.35 to 0.45.

Another embodiment provides a well cementing geopolymer composition including: (i) at least one Class F fly ash material having less than or equal to 15 wt % of calcium oxide; (ii) at least one reactive aluminosilicate from the group of blast furnace slag, Class C fly ash, vitreous calcium silicate, and kiln dust; (iii) an alkali silicate activator solution with a molar SiO₂/M₂O ratio less than or equal to 0.5; and (iv) a powdered soluble alkali silicate glass.

Another embodiment provides a well cementing geopolymer composition including: (i) at least one Class F fly ash material having less than or equal to 15 wt % of calcium oxide; (ii) at least one reactive aluminosilicate from the group of blast furnace slag, metakaolin, Class C fly ash, vitreous calcium silicate, and kiln dust; (iii) an alkali hydroxide/alkali carbonate solution; and (iv) a powdered soluble alkali silicate glass.

In one embodiment, Class F fly ash and a reactive aluminosilicate are blended and then mixed with aqueous alkali silicate activator solution to form a sellable geopolymer suspension that possesses desirable properties for well cementing application.

In one embodiment, Class F fly ash, a reactive aluminosilicate, and a powdered soluble alkali silicate glass are pre-blended and then mixed with aqueous alkali hydroxide or alkali silicate activator solution to form a settable geopolymer suspension that that possesses desirable properties for well cementing application.

A pumpable composition or pumpable geopolymer composition for a well sealing application ideally has a viscosity less than or equal to 4 poises or 400 mPa·s (e.g., at a shear rate of 100 s⁻¹) and the suspension should be stable, e.g., little separation occurs. When the viscosity of the suspension exceed a few Pas, it becomes too difficult to pump. Setting transforms the suspension from workable plastic slurry into a rigid material. Therefore, knowing the setting time of the well sealing slurry is essential for scheduling the drilling operation. It must remain in a fluid state for a certain period of time while it is pumped into place when the slurry is subject to high temperatures and high pressures such as from 35° C. to >140° C. and from about 10 to about 70 MPa. Preferably, this available pumping time is about at least 6 hours. The geopolymer slurry should set and harden shortly after being placed. The hardened material should develop a high compressive and flexural strength after about 48 hours to retain the well-sealing integrity and to securely isolate producing zones and restrain unwanted fluid production.

Numerous compounds have been successfully used for retarding the set times of Portland cement based cementing materials. Examples of these retarders include: lignosulphonates, hydroxycarboxylic acids, saccharine, cellulose derivatives such as Polysaccharide, organophosphates such as alkylene phosphonic acids, and certain inorganic compounds such as sodium chloride and oxides of zinc and lead. The respective mechanisms for the retarding effect are well understood. However, most of these retarders that work well in the Portland cement based well cementing materials do not necessarily work effectively in geopolymer systems that are cured particularly cured at elevated temperatures. The patents of the prior art pertinent to pumpable geopolymer compositions for oilfield well application disclose various retarders that may efficiently extend the set times, e.g., U.S. Pat. Nos. 7,794,537, 7,846,250, and 9,206,343. According to the work conducted by the disclosed invention, certain retarders do work well in the geopolymer compositions to extend set times at elevated temperatures. However, the retarders may cause a significant reduction in early compressive strength of the hardened materials due to enhanced interaction between the retarder and the silicate species, resulting in an extremely low release rate of soluble silicate to participate geopolymerization during curing, particularly when the dosage is high.

The present invention discloses new approaches to formulate a geopolymer composition that meets the technical requirements for well cementing without use of a retarder and yields a chemically and mechanically durable hardened material.

### Two Binder System

Select embodiments of the current invention utilize two binder additives at the same time in a geopolymer composition for a well cementing application. One is usually a less reactive aluminosilicate binder such as Low-Ca FFA and another is a more reactive aluminosilicate binder such as blast furnace slag, Class C fly ash or metakaolin. Appropriate proportion of the two binders with a distinctly different reactivity allows controlling rates of thickening and setting and modifies the rheological properties of the geopolymer slurry in a more precise way.

“Reactivity” is herein defined as the relative mass of a binder pozzolan that has reacted with an alkaline solution. In addition to Low-Ca FFA, these less reactive aluminosilicate binders include volcanic ash, tuff, and ground waste glass. Fly ashes with smaller particle sizes are preferred, such as ultrafine fly ash (UFFA) with a mean particle size of about 1 to 10 μm. UFFA is carefully processed by mechanically separating the ultrafine fraction from the parent fly ash. Finer fly ash reduces the w/b ratio to achieve the viscosity required for a pumpable geopolymer composition. Coal gasification fly ash is discharged from coal gasification power stations, usually as SiO₂ rich substantially spherical particles having a maximum particle size of about 5 to 10 μm. Thus, coal gasification fly ash is also suitable. Low-Ca FFA geopolymer sets and hardens very slowly and has a low final strength if cured at low temperatures (e.g., room temperature). Disclosed embodiments find that the reactivity of Low-Ca FFA, which determines the rate of thickening and setting depends strongly on curing temperatures. In accordance with disclosed measurements, the activation energy for alkali activation is as high as about 100 kJ/mol for Class F fly ash-based geopolymer in the temperature range of 20 to 75° C. In comparison, activation energies for Portland cements and blast furnace slag range from 20 to 50 kJ/mol. Therefore, the effect of temperature on curing of Low-Ca FFA geopolymer could be much more pronounced. In addition, the molar Si/Al ratio in the glass phase of a Low-Ca FFA is close to 4, an ideal value for the geopolymer or alkali aluminosilicate gel composition. Thus, FFA may be activated by a silicate-free alkaline activator solution effectively at a high curing temperature but still with a good strength.

In one embodiment, the Low-Ca FFA can be a fly ash which comprises less than or equal to about 8 wt % of calcium oxide. The classification of fly ash is based on ASTM C618, which is generally understood in the art. In one embodiment, the FFA comprises less than or equal to about 5 wt % of calcium oxide. In one embodiment, the fly ash should contain at least 65 wt % amorphous aluminosilicate phase and have a mean particle diameter of 60 μm or less, such as 50 μm or less, such as 45 μm or less, such as 30 μm or less. In one embodiment, the FFA has a Loss On Ignition (LOI) less than or equal to 5%. In one embodiment, the fly ash has a LOI less than or equal 1%.

The second binder usually dissolves in an alkaline solution at a much faster rate than the low Ca FFA particles. Accordingly, the geopolymers slurry made from one of these binder materials set and hardens much faster than one made of low Ca FFA. Some examples of this group of materials are metakaolin, blast furnace slag, kiln dust, and vitreous aluminosilicate (VCAS) VCAS is a waste product of fiberglass production. In a representative glass fiber manufacturing facility, typically about 10-20 wt % of the processed glass material is not converted to final product and is rejected as a by-product or waste and sent for disposal to a landfill. VCAS is 100% amorphous and its composition is very consistent, mainly including 50-55 wt % SiO₂, 15-20 wt % Al₂O₃, and 20-25 wt % CaO. Ground VCAS exhibits a pozzolanic activity comparable to silica fume and metakaolin when tested in accordance with ASTM C618 and Cl240. Alkali activation of metakaolin yields a typical geopolymer gel which is alkali aluminosilicate. In contrast, alkali activation of blast furnace slag, high Ca FFA, Class C fly ash or VCAS yields essentially CSH and/or CASH gels. Quick precipitation of these gel materials shortens thickening and setting times and increases rate of strength gain as well as final strength of the product. However, alkali activation of metakaolin that forms an ideal geopolymer gel composition, e.g., molar SiO₂/Al₂O₃˜4 and M₂O/Al₂O₃˜1) requires a much higher alkali silicate concentration in the alkali activator solution than blast furnace slag. When a high alkali silicate concentration must be used, molar alkali hydroxide concentration becomes much higher, and thus rates of thickening and setting increase greatly. Therefore, a preferred second binder is blast furnace slag. For another reason, blast furnace slag can be activated by a silicate-free activator solution such as with alkali hydroxide, alkali sulfate or alkali carbonate. In the presence of a silicate-free activator solution, it is easier to control rates of thickening and setting of a geopolymer slurry, but it is still able to yield a strong, hardened material. Blast furnace slag covered by ASTM C 989-82 should be used in a geopolymer composition for well cementing application with grades of at least 80 and preferably grade 120 or equivalent.

In one embodiment, the second binder replaces up to 30% of the first binder in a geopolymer composition for well cementing application. In one embodiment, the second binder replaces up to 20% of the first binder in a geopolymer composition for well cementing application. In one embodiment, the second binder replaces up to 10% of the first binder in a geopolymer composition for well cementing application.

### Aqueous Low-Silicate Alkaline Activator

The key constraining parameters for an alkaline activator solution include molar concentration of MOH where M=Na, K, molar ratio of SiO₂/M₂O where M=Na, K, and w/b. Precise control of rates of thickening and setting of a geopolymerslurry can be realized through adjusting these key constraining parameters individually or collectively. In general, the viscosity decreases with increasing w/b and thickening and setting times decreases with increasing molar MOH and SiO₂/M₂O ratio. A large w/b, a low molar MOH and a low SiO₂/M₂O ratio favor in producing geopolymer slurry that may meet the technical requirements for the well cementing application. The alkaline activator with a higher SiO₂/M₂O ratio provides more soluble silicate that could instantly react with calcium released from blast furnace slag or Class C fly ash to form CSH and/or CASH gels that significantly shorten thickening and setting times. However, a high SiO₂/M₂O is necessary for manufacturing concrete products with properties and performances appropriate for building and construction applications. The geopolymer compositions disclosed in the prior art used for construction and building applications usually employ a molar SiO₂/M₂O ratio greater than 0.75. For example, US Patent Application No. US2007/0125272 discloses an alkaline activator solution with a SiO₂/M₂O ratio greater than 0.8. U.S. Pat. No. 8,202,362 disclose a geopolymeric cement requiring a SiO₂/M₂O ratio greater than 1.28. U.S. Pat. No. 8,444,763 discloses an alkali activator solution with a SiO₂/M₂O ratio between 1.6 and 2.0.

The present invention discloses an alkaline activator solution that has a molar SiO₂/M₂O ratio less than or equal to 0.75. In one embodiment, the molar SiO₂/M₂O ratio is less than or equal to 0.50. In one embodiment, the molar SiO₂/M₂O ratio is less than or equal to 0.25. In one embodiment, the alkaline activator solution contains no soluble silicate (molar SiO₂/M₂O ratio is equal to 0). At such a low molar SiO₂/M₂O ratio, thickening and setting times can be greatly extended due to much less soluble silicate available to react with calcium leached from blast furnace slag or Class C fly ash and little precipitation of CSH and/or CASH gels occur at the early curing time.

In one embodiment, the silicate-free alkaline activator solution further comprises an alkali carbonate or alkali sulfate. Examples of these alkali salts include sodium carbonate, sodium sulfate, potassium carbonate and potassium sulfate. These salts can enhance the gel formation but have less impact on thickening and setting times of a geopolymer composition. An equivalent alkali hydroxide should be calculated including the alkalis from these salts.

In one embodiment, Low-Ca FFA and BFS together are employed as the binder; the w/b ratio is from about 0.28 to about 0.50 and more preferably from 0.35 to 0.45; the molar alkali hydroxide concentration in the activator solution is from about 3 to about 10 where M=K, Na, and more preferably from about 4 to about 8, and the molar SiO₂/M₂O ratio is from about 0.0 to about 0.75 and more preferably from about 0.25 to 0.50.

One embodiment described herein provides geopolymer compositions that can be used in well sealing or well cementing applications in oil and gas industries. A well cementing geopolymer composition comprises: (i) at least one FFA material having less than or equal to 15 wt % of calcium oxide; (ii) at least one reactive aluminosilicate from the group of blast furnace slag, metakaolin, Class C fly ash, vitreous calcium silicate, and kiln dust; and (iii) an aqueous alkaline silicate activator that has a low molar ratio of SiO₂/M₂O where M=Na, K, preferably less than or equal to 0.75. The aqueous alkali silicate activator should have a low molar alkali hydroxide concentration, preferably less than 8. The w/b ratio must be large enough to produce a well cementing slurry that are pumpable, preferably from about 0.28 to about 0.50 and more preferably from about 0.35 to about 0.45.

### Control of Setting by a Powdered Alkali Silicate Glass

Disclosed embodiments of the present invention provide a new method to more effectively control thickening and setting times of a geopolymer composition at elevated temperatures. When a silicate-free alkaline activator solution is employed, it takes a much longer time to accumulate dissolved silicate in the geopolymer slurry before a massive precipitation of geopolymer and/or CSH/CASH gels occurs. Therefore, thickening and setting times are greatly extended at elevated temperatures. The present invention employs a silicate-free alkaline activator solution and powdered, soluble alkali silicate glass. The powdered alkali silicate glass is blended together with other dry ingredients. Upon exposure to an alkaline, silicate-free activator solution, the alkali silicate glass particles slowly and gradually dissolve and release silicate species that is available for geopolymerization. The dissolution of these glass particles is usually enhanced by curing at elevated temperatures. The dissolution rate of a powdered alkali silicate glass mainly depends on glass composition, particle size, curing temperatures, and molar MOH concentration and the relationship can be established, allowing controlling rates of thickening and setting of the geopolymer slurry more precisely at elevated temperatures. Practically, there is little soluble silicate in the geopolymer slurry in a few hours of curing. Significant amounts of alkali and silicate species released from the dissolution of alkali silicate glass particles will accumulate and participate geopolymerization toward the late curing phase, resulting in high strength of the hardened materials. Examples of these soluble alkali silicate glasses include Kasil® SS (potassium silicate glass, SiO₂/K₂O=2.5, 48% through 200 mesh), SS®-C200 (sodium silicate glass, SiO₂/Na₂O=2.0, 97% through 200 mesh) and SS®200 (sodium silicate glass, SiO₂/Na₂O=3.2, 97% through 200 mesh) from PQ, Corp. Any powdered alkali silicate glass that can dissolve in an alkaline solution at an appropriate rate is desirable.

In one embodiment, low Ca FFA and BFS are employed as the binder. An alkaline, silicate-free solution is employed as the aqueous activator and at the same time, a powered, soluble potassium silicate glass as the solid activator. SiO₂/M₂O (M=K, Na) is from about 0.25 to about 2.0 and preferably from about 0.40 to about 1.25. The Equivalent molar MOH (M=Na, Na) is from about 3 to about 10 and more preferably from about 4 to about 8. Equivalent molar MOH and SiO₂/M₂O are calculated by including alkalis and silicate from both the alkaline activator solution and the powdered alkali silicate glass.

In one embodiment, low Ca FFA and BFS are employed as the binder; an alkaline silicate solution with a molar SiO₂/M₂O ratio from about 0.0 to about 0.50 is employed as the aqueous activator; and at the same time, a powered, soluble alkali silicate glass is employed as the solid activator. The combined molar SiO₂/M₂O (M=K, Na) is from about 0.25 to about 2.0 and preferably from about 0.40 to about 1.25. Molar MOH (M=Na, Na) is from about 3 to about 10 and more preferably from about 4 to about 8. The w/b ratio is about 0.28 to about 0.55, preferably from 0.35 to about 0.45.

In one embodiment, low Ca FFA and BFS are employed as the binder; an alkaline silicate-free solution containing an alkali carbonate is employed as the aqueous activator; and at the same time, a powered, soluble alkali silicate glass is used as the solid activator. The combined molar SiO₂/M₂O (M=K, Na) is from about 0.25 to about 2.0 and preferably from about 0.40 to about 1.25. The equivalent Molar MOH (M=Na, Na) is from about 3 to about 10 and more preferably from about 4 to about 8. Both equivalent molar MOH and SiO₂/M₂O are calculated by including the alkali and silicate from the activator solution and the powdered alkali silicate glass.

One embodiment provides a well cementing geopolymer composition (i) at least one FFA material having less than or equal to 15 wt % of calcium oxide; (ii) at least one reactive aluminosilicate from the group of blast furnace slag, metakaolin, Class C fly ash, vitreous calcium silicate, and kiln dust; (iii) an alkaline silicate-free activator solution; and iv) a powdered soluble alkali silicate glass. The combined molar SiO₂/M₂O (M=K, Na) is from about 0.25 to about 2.0 and preferably from about 0.40 to about 1.25. The equivalent Molar MOH (M=Na, Na) is from about 3 to about 10 and more preferably from about 4 to about 8. Both equivalent molar MOH and SiO₂/M₂O are calculated by including the alkali and silicate from the activator solution and the powdered alkali silicate glass. A large w/b ratio is employed to produce a well cementing slurry that is pumpable, preferably from about 0.28 to about 0.55 and more preferably from 0.35 to 0.45.

### Superplasticizer

It is well known that superplasticizer products do not work with a geopolymer slurry as effectively as with a Portland cement slurry to reduce w/b and to improve rheological properties at a manufacture recommended dosage. Higher ion strength of an alkaline activator solution interferes with functioning of superplasticizer solids in the geopolymer slurry. Disclosed embodiments discover that a superplasticizer becomes effective in reducing w/b and improving workability in a geopolymer composition only when the dosage is high enough. For example, a dosage of superplasticizer solids should be at least 0.05% by weight of the combined binder (BWOB) to take effects in reducing w/b and improve rheological properties. Addition of superplasticizer solids has various benefits. Reducing the water content allows achieving the viscosity required for the pumpable slurry and it improves compressive strength of the hardened geopolymer. It may also reduce separation during pumping, improve flexural strength, and reduce shrinkage and porosity of the hardened geopolymer.

In one embodiment, the superplasticizer solids are from about 0.0 to about 0.75% by BWOB and preferably from about 0.05 to 0.5 w % BWOB.

### Fillers

Geopolymer, as Portland cements do continue to shrink after setting and during hardening. Appropriate proportioning of a geopolymer composition and use of admixture and additives can improve rheological performance and limit the effects of shrinkage. In addition to careful control of water content by using superplasticizers, the present invention provides other methods to improve rheological properties of the pumpable geopolymer slurry.

Embodiments of the disclosed invention discover that addition of ultrafine and submicron particles may significantly reduce the w/b ratio of a geopolymer composition required for a pumpable slurry. In addition, these particles improve the particular packaging density of a geopolymer slurry thus reduce shrinkage and improve mechanical durability of a hardened geopolymer. Three types of fillers can be classified in terms of their particle sizes and reactivity in an alkaline solution. One type of fillers comprises mainly reactive submicron particles having a particle size of between about 0.05 to 1 μm. Examples of these submicron fillers are silica fume, precipitated silica, or ultrafine calcium carbonate. The second type of fillers comprises fine and ultrafine particles having particle sizes of between about 1 to 50 μm. Examples of these fillers include crushed quartz powders, clays particles, and various zeolite types. Examples of crushed quartz powders include MIN-U-SIL® Fine Ground Silica products from US Silica. The third type of fillers has an expansive property upon exposure to an alkaline solution. Examples of these expansive fillers include silica fume, calcined MgO and vitreous aluminosilicate. Silica fumes, weather gray or white always contain a few percentages of metallic silicon. Air bubble evolves during the early curing time when metal silicon particles react with hydroxide to emit hydrogen gas, causing a volumetric expansion. Calcined MgO particles hydrate during early curing time causing a volumetric expansion as well. The embodiments of the disclosed invention discover that alkali activation of VCAS is an expansion process. A slight volumetric expansion is desirable for the well cementing process because it can compensate shrinkage that is present during curing.

In one embodiment, the filler of one type or combined can be added up to 50% of a geopolymer composition, preferably up to about 25% and more preferably 5%.

### Set Retarders

Optionally, one or more set retarders may be included to a geopolymer composition. Examples of set retarders include boron compounds such as borax, alkali phosphates, barium salts, and metal nitrate such as zinc nitrate. These retarders should be used only if necessary because a negative impact on early strength of the hardened geopolymer can be evident. A low dosage should be used so that negative effect on early strength of the hardened geopolymer is minimized.

Having described the many embodiments of the present invention in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

### EXAMPLES

The following examples illustrate the practice of the present invention in select disclosed embodiments.

Two fly ashes were used for preparing well cementing geopolymers that are pumpable. One was a low CaO FFA (1.39%) from Orlando Unit 2 Power Station, Fla., marketed by Headwater Resources (Orlando fly ash). This fly ash has a LOI over 5% which was outside the ASTM C618 Class F specifications. Its sum of Si+Al+Fe oxides is 90.65%. Second fly ash was a low CaO (4.77%) FFA from Navajo Power Station, NV, marketed by Headwaters Resources (Navajo fly ash). This FFA has an LOI of ˜0.15%. Its sum of Si+Al+Fe oxides is 87.00%. The BFS grade 120 was from the Lafarge-Hakim's Sparrow Point plant in Baltimore, Md. Activity index was about 129 according to ASTM C989. The blast furnace slag contained about 38.5% CaO, 38.2% SiO₂, 10.3% Al₂O₃, and 9.2% MgO with a mean particle size of 13.8 μm and 50 vol % less than 7 μm.

Type Ru sodium silicate solution from PQ, Corp was used to prepare alkali silicate activator solution. The mass ratio of SiO₂/Na₂O was about 2.40. The solution as received contains about 13.9 wt % Na₂O, 33.2 wt % SiO2 and 52.9 wt % water.

Kasil SS potassium silicate glass from PQ, Corp was used as the solid alkali silicate activator. The mass ratio of SiO₂/K₂O was about 2.50. About 47% particles passed through 200 mesh. However, Kasil SS powders were sieved to pass through 200-mesh for manufacturing well cementing geopolymers, and always added to the mixer together with other solid ingredients such as FFA and/or BFS.

Viscocrete 2100 from Sika Corp was used which is a polycarboxylate polymer based high range water reducing and superplasticizing admixture. The dosage was about 0.4% as solids by weight of the total binder (fly ash or fly ash and blast furnace slag). Two retarders were used, one was so called BC and another one was borax, BX in short.

Available pumping time is the time when a pumpable geopolymer suspension reaches an un-pumpable consistency before setting. The available pumping time (fluid phase time) of geopolymer slurry can be estimated by a high temperature/high pressure consistometer by determining thickening time of geopolymer slurry. However, it may be estimated by a simple laboratory testing procedure. The available pumping time must be considered in the context of whether the slurry is subjected or not to shear stress during the early curing time before setting. Stirring the samples during curing, is more representative of the real situation, because the geopolymer slurries would be pumped into wells under pressure, e.g., a few thousands of psi. Therefore, the geopolymer slurry would always be under constant shear stress in order to keep flowing. Geopolymer slurry samples were subject to manually stirring once every hour. After curing for a while at 50° C. and if a slurry sample became pourable after stirring with a spatula without much effort, then the slurry was considered to be pumpable. Set times were estimated by using a manual Vicat. Both available pumping time and set times may be reported to be over a value, e.g., over about 6 hours because the testing was extended to the evening session when no staff was available.

Selected fresh geopolymer samples were measured for viscosity at shear rates up to 1000 s⁻¹ by a Haake rheometer RS600 with ROTOR Z40DIN. The measurements usually began 15 min after completing the sample preparation. The temperature was about 25° C. The viscosity at a shear rate of 100 s⁻¹ was reported, in Poises (P) or mPa·s. 1 Poise equals to 100 mPa·s. A pumpable slurry usually has a viscosity of less than a few Pa·s at 100 s⁻¹.

Compressive strength was measured on Test Mark compression machine CM-4000-SD after curing at 50° C. for about 2-7 days and about 28 days. During the testing, all samples were capped with rubber pads. The compression machine was calibrated with NIST traceable standards.

### General Sample Preparation Procedure

When used, retarders were dissolved in tap water and the solution was then mixed with the alkaline solution for 30 min before sample preparation. The solution was then mixed together with the solid ingredients—fly ash, blast furnace slag, and Kasil SS (when used), in a Waring 7-QT planetary mixer for 4 minutes at an intermediate speed. When used, the superplasticizer was added separately during mixing at a dosage of about 0.25 to 0.45% solids BWOB. Sample batches weighted between 2200 to 4000 grams. 2″×4″ cylindrical samples were prepared for compressive strength measurement, and about five 100 ml cups were filled with the paste in order to estimate the available pumping time or fluid phase time. In addition, a sample for set time estimation was prepared. All these samples were properly sealed, placed in a water filled container and moved to an oven preset at 50° C. for curing. Note, the samples from all the examples described below were all subject to curing at 50° C. except where indicated.

The examples shown in Table 1 demonstrate the possibility to control thickening and set times of the geopolymer slurries by activating a single fly ash binder or a binary FFA/BFS binder composition with an alkaline silicate activator solution that possesses a low molar MOH, a small molar ratio of SiO₂/Na₂O, and preferably without use of a retarder. On the contrary, the alkaline activator solutions for manufacturing useful construction materials usually requires a molar ratio of SiO₂/Na₂O greater than 0.75. In addition, much higher superplasticizer solids were used to reduce the w/b ratio that needed for pumpable geopolymer slurry.

### Example 1

To make the alkaline activator solution, NaOH flake (99 wt % assay) was added to the tap water to dissolve and then combined with Ru TM sodium silicate solution (PQ Incorporation). The activator solution was prepared such that it contains the required amounts of Na₂O, SiO₂ and H₂O to meet the respective target w/b, molar MOH (M=Kor Na), and molar ratio of SiO₂/M₂O (M=K, Na) shown in Table 1. The molar ratio of SiO₂/M₂O was about 0.75. w/b was 0.40 and molar NaOH was 5. The activator was mixed with the Orlando fly ash in a Waring 7-QT planetary mixer for 4 minutes at an intermediate speed. No BFS was added. The slurry was poured into 2″×4″ cylindrical samples and vibrated on a vibration table for 3 minutes. Additionally, about five 100 ml cups were filled with the paste in order to estimate the available pumping time or fluid phase time. One sample was also prepared for set time estimation. All these samples were properly sealed, placed in a water-filled container and moved to an oven preset at 50° C. for curing. The available pumping time was found to be less than 3 hours. The compressive strength was 483 psi after curing for 48 hours and 1433 psi after 28 days.

TABLE 1

| | Viscosity | BFS | | SiO₂/ | | Molar | | Set | Compressive | |
|---|---|---|---|---|---|---|---|---|---|---|
| Example | @100 s⁻¹ | Replacement | Retarder | M₂O | w/b | NaOH | APT, h | Time, h | Strength, psi | |
| #1 | ND | 0% | 0.0% | 0.75 | 0.40 | 5.0 | <3 | >6 | 483 | 1433 |
| #2 | ND | 0% | 0.5% BC | 0.25 | 0.28 | 5.0 | >7 | >7 | 423^{3D} | 1795 |
| #3 | ND | 0% | 0.0% | 0.25 | 0.30 | 5.0 | >7 | <24 | 90 | 2117 |
| #4 | ND | 4% | 0.5% BC | 0.25 | 0.28 | 5.0 | <4 | ~5 | 1138^{4D} | 2432 |
| #5 | ND | 2% | 0.25% BC | 0.25 | 0.30 | 5.0 | >7 | <24 | 233 | 2409 |
| #6 | 8.07 P | 2% | 0.25% BC | 0.25 | 0.30 | 5.0 | >6 | <24 | 282 | 2321 |
| #7 | 5.12 P | 3% | 1.0% BX | 0.25 | 0.33 | 5.0 | >7 | ~24 | 76 | 1993 |
| #8 | 3.91 P | 6% | 0.0% | 0.25 | 0.36 | 5.0 | >6 | ~24 | 75 | 2647 |
| #9 | 3.92 P | 8% | 0.0% | 0.25 | 0.38 | 6.0 | >7 | ~24 | 359 | 6176 |

APT = available pumping time;
M = K, Na;
w/b = water to binder ratio;
ND = not determined

### Example 2

FFA from Navajo Power Station, Arizona, USA was use as the single binder in Example 2. The activator solution was prepared such that it contains the required amounts of Na₂O, SiO₂ and H₂O to meet w/b of 0.28, a molar NaOH of 5 and a molar ratio of SiO₂/Na₂O of 0.25 (Table 1). In the case of a sodium silicate solution, the molar ratio of SiO₂/Na₂O is very close to the value for its mass ratio. The procedure for the sample preparation was the same as in Example 1. However, a low dosage of retarder BC (0.5% BWOB) was used. The retarder was dissolved in tap water, and then the solution was mixed with the sodium silicate solution 30 minutes before preparing the sample. Both available pumping and the set times were greater than 7 hours. The compressive strength was 423 psi after curing for 3 days and 1795 psi after curing for 28 days.

### Example 3

FFA from Navajo Power Station, Arizona, USA was use as a single binder in Example 3. The activator solution was prepared such that it contains the required amounts of Na₂O, SiO₂ and H₂O to meet w/b of 0.30, a molar NaOH of 5 and a molar ratio of SiO₂/Na₂O of 0.25 (Table 1). The procedure for the sample preparation was the same as in Example 1. No retarder was used. The available pumping time was greater than 7 hours and the set time was close to 24 hours. The compressive strength after curing for 48 hours was only 90 psi. However, the compressive strength increased to 2117 psi after curing for 28 days.

Examples 4 to 9 demonstrate that use of a more reactive aluminosilicate binder in addition to the less reactive FFA to achieve desirable properties when a large w/b is used.

### Example 4

The fly ash was replaced by blast furnace slag by 4% in the recipe of Example 2, yielding a geopolymer composition for Example 4 (Table 1). The procedure for preparing Example 4 was the same as in Example 2. Both available pumping time and set time were slightly reduced because of increased content of blast furnace slag. The compressive strength was significantly higher, about 1138 psi after curing for 4 days. The compressive strength was to 2432 psi after curing for 28 days.

### Example 5

The fly ash was replaced by blast furnace slag by 2% in the recipe of Example 3, yielding a geopolymer composition for Example 5 (Table 1). The procedure for the sample preparation was the same as in Example 2. In addition, a low dosage of the BC retarder (0.25% BWOB) was added. The available pumping time was still greater than 7 hours. However, the compressive strength was increased to 233 psi after curing for 48 hours and increased to 2409 psi after curing for 28 days. Both examples 4 and 5 demonstrate that addition of more reactive aluminosilicate such as blast furnace slag is able to increase early strength of the hardened geopolymer at the same time fresh properties of pumpable geopolymer slurry are not significantly affected.

### Examples 6-9

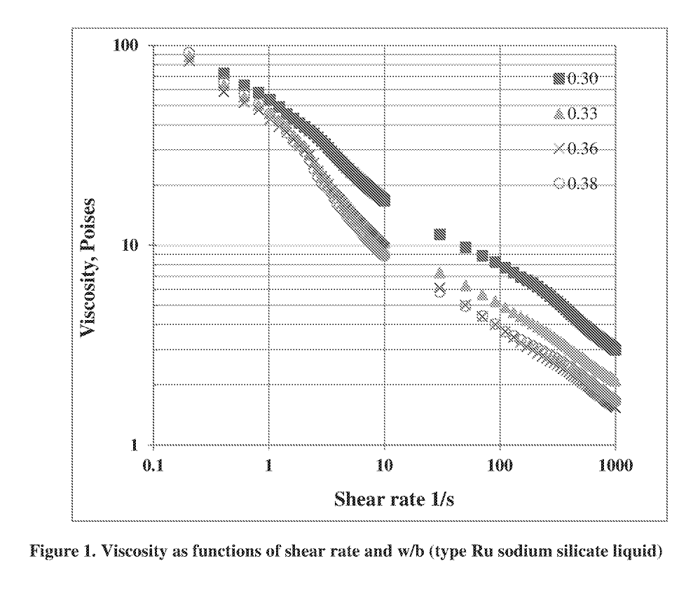

Examples 6 through 9 demonstrate that viscosity of geopolymer slurry decreases with increasing w/b and how increasing replacement of fly ash by blast furnace slag compensates loss of compressive strength due to increasing w/b (Table 1). FIG. 1 shows viscosity as functions of shear rate and the w/b ratio.

Example 6 is a duplicate of Example 5 and both examples yielded almost identical available pumping times, set times and compressive strengths. In addition, about 200 grams of geopolymer slurry from Example 6 was subject to rheological measurements. The viscosity at 100 s⁻¹ was 8.07 poises or 807 mPa·s. While w/b was increased from 0.30 in Example 6 to 0.33 in Example 7, the replacement of fly ash by blast furnace slag was increased from 2% in Example 6 to 3% in Example 7. The available pumping time and set time remained unchanged. Viscosity at 100 s⁻¹ decreased from 8.07 poises or 807 mPa·s for Example 6 to 5.12 poises or 512 mPa·s for Example 7. However, the compressive strength was dropped to 76 psi after curing for 48 hours and increased to 1993 psi after curing for 28 days, indicating that 1% increase in blast furnace slag was not enough to compensate the loss of early strength due to increased w/b.

While w/b was increased from 0.33 in Example 7 to 0.36 in Example 8, the replacement of fly ash by blast furnace slag was increased from 3% in Example 7 to 6% in Example 8. The available pumping time and set time remained unchanged. Viscosity at 100 s⁻¹ decreased from 5.12 poises or 512 mPa·s for Example 7 to 3.91 poises or 391 mPa·s for Example 8. The compressive strength remained the same, about 75 psi after curing for 48 hours. However, the compressive strength was increased to 2647 psi after curing for 28 days, indicating that a 3% increase in blast furnace slag was not enough to compensate the loss of early strength due to increased w/b.

While w/b was increased from 0.36 in Example 8 to 0.38 in Example 9, the replacement of fly ash by blast furnace slag was increased from 6% in Example 8 to 8% in Example 9 and the molar NaOH was increased from 5 to 6. The available pumping time, set time and viscosity at 100 s⁻¹ remained unchanged. The compressive strength was increased from 75 psi to 359 psi after curing for 48 hours. The compressive strength increased to 6176 psi after curing for 28 days. The available pumping time for Example 9 was estimated to be over 7 hours. Therefore, it is expected that increasing GGBFS replacement further to 10-12% or increasing molar NaOH over 6 could yield compressive strengths of at least 500 psi after curing for 48 hours while the desirable rheological and fluid properties would be maintained.

The examples shown in Table 2 demonstrate the possibility to control thickening and set times of the geopolymer slurries by activating a single fly ash binder or a binary FFA/BFS binder with an alkaline silicate-free activator solution and a powdered alkali silicate glass without use of a retarder. Again, much higher superplasticizer solids were used to reduce the w/b ratio that needed for pumpable slurry as compared to the geopolymers used for construction applications.

TABLE 2

| | | | | | | | | | Compressive | |
|---|---|---|---|---|---|---|---|---|---|---|
| | Viscosity | BFS | | SiO₂/ | | Molar | | Set | Strength, psi | |
| Sample | @100 s⁻¹ | Replacement | Retarder | M₂O | w/b | MOH | APT, h | Time, h | 48 h | 28 d |
| #10 | ND | 4% | 0.0% | 0.75 | 0.30 | 5.0 | ~ 6 | <22 | 333 | 1162 |
| #11 | ND | 4% | 1.25% BX | 0.40 | 0.35 | 5.0 | >6 | <24 | 130^{1D} | 994 |
| #12 | ND | 0% | 0.0% | 0.40 | 0.35 | 5.0 | >>6 | ~24 | 110 | 507 |
| #13 | 10.78 P | 4% | 0.0% | 0.75 | 0.30 | 5.0 | >6 | <24 | 326 | 1117 |
| #14 | 9.17 P | 6% | 0.0% | 0.75 | 0.35 | 5.0 | >6 | ~24 | 312 | 1046 |
| #15 | 5.04 P | 8% | 0.0% | 0.75 | 0.375 | 5.0 | >7 | ~24 | 269 | 674 |
| #16 | 4.41 P | 10% | 0.0% | 0.75 | 0.40 | 5.0 | >7 | <24 | 384 | 1178 |
| #17 | 3.16 P | 10% | 0.0% | 0.75 | 0.42 | 6.0 | >7 | <24 | 479 | 1480 |

APT = available pumping time;
M = K, Na;
w/b = water to binder ratio;
ND = not determined

### Example 10

About 4% of fly ash was replaced by blast furnace slag. To make the alkaline silicate-free activator solution, NaOH flake (99 wt % assay) was added to the tap water to dissolve. Powdered Kasil SS potassium silicate glass from PQ Corp was blended with other solid ingredients (fly ash, blast furnace slag). NaOH, tap water, and Kasil SS powders were added at such amounts that the geopolymer composition contains the required amounts of Na₂O, K₂O, SiO₂ and H₂O to meet the respective target w/b, molar MOH (M=K, Na), and molar ratio of SiO₂/M₂O (M=K, Na) shown in Table 2. The molar ratio of SiO₂/M₂O was about 0.75, w/b was 0.40 and molar NaOH was 5. The alkaline silicate-free activator solution was mixed with the blend of fly ash, blast furnace slag, and Kasil SS powders in a Waring 7-QT planetary mixer for 4 minutes at intermediate speed. The available pumping time was estimated to be about 6 hours and set time was less than 24 hours. The compressive strength was about 333 psi after curing for 48 hours and increased to 1162 psi after curing for 28 days (Table 2).

### Example 11

While the molar ratio of SiO₂/M₂O was decreased from 0.75 in Example 10 to 0.40 in Example 11, w/b was increased to 0.35 to improve pumpability of a geopolymer slurry. In addition, borax was added as a retarder at a dosage of 1.25% BWOB. The available pumping time was found to be over 6 hours and set time was less than 24 hours. The compressive strength was 131 psi after curing for 24 hours and 994 psi after curing for 28 days (Table 2).

### Example 12

Removal of blast furnace slag and retarder from the recipe for Example 11, yielded a geopolymer composition for Example 12. As expected, the available pumping time was extended, far over 6 hours. However, compressive strengths decreased after curing for 48 hours and 28 days, respectively (Table 2). This indicates that a high content of more reactive aluminosilicate such as BFS is needed for improving early strength of a hardened geopolymer.

### Examples 13 to 17

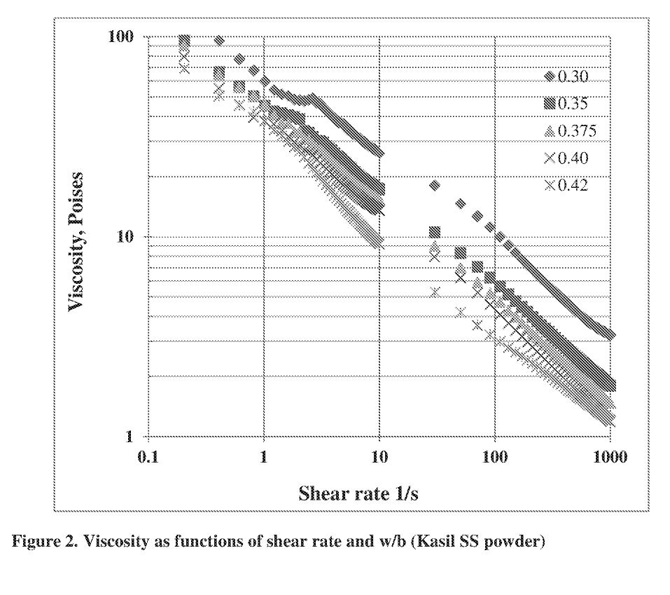

Examples 13 through 17 demonstrate that the viscosity of geopolymer slurry prepared with a alkaline silicate-free activator solution and a powdered alkali silicate glass decreases with increasing w/b and how increasing replacement of fly ash by blast furnace slag compensates loss of compressive strength due to increased w/b (Table 2). FIG. 2 shows viscosity as functions of shear rate and the w/b ratio.

Example 13 is a duplicate of Example 10 where the molar SiO₂/M₂O was 0.75, molar MOH was 5, and w/b was 0.30. All the properties measured were almost identical. The viscosity at 100 s⁻¹ was 10.78 poises or 1078 mPa·s.

While w/b was increased from 0.30 in Example 13 to 0.35 in Example 14, the replacement of fly ash by blast furnace slag was increased from 4% in Example 13 to 6% in Example 14. The available pumping time and set time remained unchanged. Viscosity at 100 s⁻¹ decreased from 10.78 poises or 1078 mPa·s for Example 13 to 9.17 poises or 917 mPa·s for Example 14. However, the compressive strength values remained unchanged after curing for 48 hours and for 28 days, respectively.

While w/b was increased from 0.35 in Example 14 to 0.375 in Example 15, the replacement of fly ash by blast furnace slag was increased from 6% in Example 14 to 8% in Example 15. The available pumping time was estimated to be over 7 hours and set time was close to 24 hours. Viscosity at 100 s⁻¹ decreased from 9.17 poises or 917 mPa·s for Example 14 to 5.04 poises or 504 mPa·s for Example 15. The compressive strength was slightly decreased, about 269 psi after curing for 48 hours and 674 psi after curing for 28 days, indicating that a 2% increase in blast furnace slag was not enough to compensate for the loss of strength due to increased w/b.

While w/b was increased from 0.375 in Example 15 to 0.40 in Example 16, the replacement of fly ash by blast furnace slag was increased from 8% in Example 15 to 10% in Example 16. The available pumping time and set time remained unchanged. Viscosity at 100 s⁻¹ decreased to 4.41 poises or 441 mPa·s. The compressive strength was increased to 384 psi after curing for 48 hours and to 1178 psi after curing for 28 days.

While w/b was increased from 0.40 in Example 16 to 0.42 in Example 17, the molar MOH was increased from 5 in Example 16 to 6 in Example 17. The replacement of fly ash by blast furnace slag was still 8%. The available pumping time and set time remained unchanged. Viscosity at 100 s⁻¹ decreased to 3.16 poises or 316 mPa·s. The compressive strength was increased to 479 psi after curing for 48 hours and to 1480 psi after curing for 28 days.

The available pumping time for Example 17 was estimated to be over 7 hours. Therefore, it is expected that increasing blast furnace slag replacement further to 12-16% could yield a compressive strength of at least 500 psi after 48 hours while desirable rheological and fluid properties would be maintained. Additional soluble silicate or alkali carbonate added to the silicate-free activator solution could also yield a compressive strength of at least 500 psi after curing for 48 hours.

All documents, patents, journal articles and other materials cited in the present application are incorporated herein by reference.

While the present invention has been disclosed with references to certain embodiments, numerous modification, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A pumpable geopolymer composition comprising:
a less reactive aluminosilicate;
a more reactive aluminosilicate; and
an alkaline low-silicate activator solution as carrier fluid.

2. The pumpable geopolymer composition of claim 1, wherein the less reactive aluminosilicate is selected from a group consisting of: Class F fly ash, pumice, volcanic ash, and ground perlite.

3. The pumpable geopolymer composition of claim 1, wherein the less reactive aluminosilicate is Class F fly ash with CaO less than or equal to 15% and less than or equal 8%.

4. The pumpable geopolymer composition of claim 1, wherein the more reactive aluminosilicate is selected from the group consisting of: ground granulated blast furnace slag, Class C fly ash, metakaolin, vitreous calcium aluminosilicate, and kiln dust.

5. The pumpable geopolymer composition of claim 1, wherein the more reactive aluminosilicate is ground granulated blast furnace slag.

6. The pumpable geopolymer composition of claim 1, wherein a mass ratio of Class F fly ash to blast furnace slag ranges from about 0.99:0.01 to about 0.70:0.30.

7. The pumpable geopolymer composition of claim 1, wherein a mass ratio of Class F fly ash to blast furnace slag ranges from about from about 0.92:0.08 to about 0.85:0.15.

8. The pumpable geopolymer composition of claim 1, wherein the alkaline low-silicate activator solution contains alkali silicate and alkali hydroxide and water.

9. The pumpable geopolymer composition of claim 8, wherein the alkali silicate is selected from a group consisting of: potassium silicate and sodium silicate, and wherein the alkali hydroxide is selected from a group consisting of: sodium hydroxide, potassium hydroxide and lithium hydroxide.

10. The pumpable geopolymer composition of claim 1, wherein the alkaline low-silicate activator solution has a molar ratio of SiO₂/M₂O less than about 0.75; molar MOH less than about 10; and water to binder ratio from about 0.28 to about 0.50, M representing K, Na or Li.

11. The pumpable geopolymer composition of claim 1, wherein the alkaline low-silicate activator solution has a molar ratio of SiO₂/M₂O less than about 0.50; molar MOH less than about 8; and water to binder ratio from about 0.35 to about 0.40, M representing K, Na or Li.

12. The pumpable geopolymer composition of claim 1, further comprising:
a superplasticizer from about 0.05% to about 1% as solids by weight of the binder, wherein the superplasctizer is selected from a group consisting of: lignosulphonate derivative, naphthalene-based compound, melamine-based material, and polycarboxylate superplasticizing admixture.

13. The pumpable geopolymer composition of claim 1, further comprising:
one or more expansive additives comprising up to about 10% of the geopolymer composition, wherein the one or more expansive additives are selected from a group consisting of: vitreous calcium aluminosilicate, white silica fume, gray silica fume, and MgO.

14. The pumpable geopolymer composition of claim 1, further comprising:
one or more expansive additives comprising up to about 5% of the geopolymer composition, wherein the one or more expansive additives are selected from a group consisting of: vitreous calcium aluminosilicate, white silica fume, gray silica fume, and MgO.

15. The pumpable geopolymer composition of claim 1, further comprising:
ultrafine and submicron fillers comprising up to about 35 wt % of the geopolymer composition.

16. The pumpable geopolymer composition of claim 15, wherein the ultrafine and submicron fillers have a particle size of between 0.05 and 50 μm and is selected from a group consisting of: silica flour, ultrafine fly ash, silica fume, precipitated silica, micron alumina, zeolite, and clay particles.

17. The pumpable geopolymer composition of claim 1, further comprising:
ultrafine and submicron fillers comprising from about 2 to about 25 wt % of the geopolymer composition.

18. The pumpable geopolymer composition of claim 17, wherein the ultrafine and submicron fillers have a particle size of between 0.05 and 50 μm and is selected from a group consisting of: silica flour, ultrafine fly ash, silica fume, precipitated silica, micron alumina, zeolite, and clay particles.

19. The pumpable geopolymer composition of claim 1, wherein mixing all solid ingredients of the geopolymer composition with the alkaline low-silicate activator solution yields a pumpable geopolymer slurry with a room temperature viscosity of less than 5 Pa·s at a shear rate of 100 s⁻¹.

20. The pumpable geopolymer composition of claim 1, wherein mixing all solid ingredients of the geopolymer composition with the alkaline low-silicate activator solution yields a pumpable geopolymer slurry with a room temperature viscosity of less than 500 mPa·s at a shear rate of 100 s⁻¹.

21. The pumpable geopolymer composition of claim 1, wherein mixing all solid ingredients of the geopolymer composition with the alkaline low-silicate activator solution, forms a pumpable geopolymer slurry having an available pumping time of greater than 6 hours and a set time of greater than 6 hours and less than 24 hours when curing at 50° C.

22. The pumpable geopolymer composition of claim 21, wherein the pumpable geopolymer slurry forms a hardened geopolymer slurry having a compressive strength greater than 300 psi after curing for 48 hours and 1000 psi after curing for 28 days.

23. A pumpable geopolymer composition comprising:
a less reactive aluminosilicate;
a more reactive aluminosilicate;
an alkaline silicate-free activator solution as carrier fluid; and
a powdered alkali silicate glass.

24. The pumpable geopolymer composition of claim 23, wherein the less reactive aluminosilicate is selected from a group consisting of: Class F fly ash, pumice, volcanic ash, and ground perlite.

25. The pumpable geopolymer composition of claim 23, wherein the less reactive aluminosilicate is Class F fly ash with CaO less than or equal to 15%.

26. The pumpable geopolymer composition of claim 23, wherein the less reactive aluminosilicate is Class F fly ash with CaO less than or equal to 8%.

27. The pumpable geopolymer composition of claim 23, wherein the more reactive aluminosilicate is selected from a group consisting of: ground granulated blast furnace slag, Class C fly ash, metakaolin, vitreous calcium aluminosilicate, and kiln dust.

28. The pumpable geopolymer composition of claim 23, wherein the more reactive aluminosilicate is a ground granulated blast furnace slag.

29. The pumpable geopolymer composition of claim 23, wherein the mass ratio of Class F fly ash to blast furnace slag ranges from about 0.98:0.02 to about 0.70:0.30.

30. The pumpable geopolymer composition of claim 23, wherein the mass ratio of Class F fly ash to blast furnace slag ranges from about 0.92:0.08 to about 0.85:0.15.

31. The pumpable geopolymer composition of claim 23, wherein the alkaline silicate-free activator solution contains alkali hydroxide, alkali salt and water.

32. The pumpable geopolymer composition of claim 31, wherein the mass ratio of alkali salt to alkali hydroxide is from about 0.00:1.00 to 0.40:0.60, M represents K, Na.

33. The pumpable geopolymer composition of claim 31, wherein the alkali hydroxide is selected from a group consisting of: sodium hydroxide, potassium hydroxide and lithium hydroxide, and wherein the alkali salt is selected from a group consisting of: potassium carbonate, sodium carbonate, potassium sulfate and potassium sulfate.

34. The pumpable geopolymer composition of claim 23, wherein the powdered alkali silicate glass is either a sodium silicate glass with a molar ratio of SiO₂/Na₂O from about 2.0 to about 3.6 or a potassium silicate glass with a molar ratio of SiO₂/K₂O from about 1.8 to about 3.0.

35. The pumpable geopolymer composition of claim 23, wherein the powdered alkali silicate glass has a particle size passing 100 mesh.

36. The pumpable geopolymer composition of claim 23, wherein the powdered alkali silicate glass has a particle size passing 200 mesh.

37. The pumpable geopolymer composition of claim 23, wherein a molar MOH calculated from a combination of the alkaline silicate-free silicate activator solution and the powdered alkali silicate glass is less than about 10, M representing K, Na, Li.

38. The pumpable geopolymer composition of claim 23, wherein a molar MOH calculated from a combination of the alkaline silicate-free silicate activator solution and the powdered alkali silicate glass is less than about 8, M representing K, Na, Li.

39. The pumpable geopolymer composition of claim 23, wherein a molar ratio of SiO₂/M₂O calculated from a combination of the alkaline silicate-free silicate activator solution and the powdered alkali silicate glass is from about 0.25 to about 1.50, M representing K, Na or Li.

40. The pumpable geopolymer composition of claim 23, wherein a molar ratio of SiO₂/M₂O calculated from a combination of the alkaline silicate-free silicate activator solution and the powdered alkali silicate glass is from about 0.40 to about 1.25, M representing K, Na or Li.

41. The pumpable geopolymer composition of claim 23, wherein a water to binder ratio is from about 0.28 to about 0.55.

42. The pumpable geopolymer composition of claim 23, wherein a water to binder ratio is from about 0.35 to about 0.45.

43. The pumpable geopolymer composition of claim 23, further comprises a superplasticizer comprising from about 0.05% to about 1% as solids by weight of a binder and wherein the superplasticizer is selected from the a group consisting of: lignosulphonate derivative, naphthalene-based compound, melamine-based material, and polycarboxylate superplasticizing admixture.

44. The pumpable geopolymer composition of claim 23, further comprising:
one or more expansive additives comprising up to about 10%, wherein the expansive additive is selected from a group consisting of: vitreous calcium aluminosilicate, white silica fume, gray silica fume, and MgO.

45. The pumpable geopolymer composition of claim 23, further comprising:
one or more expansive additives comprising up to about 5% of the geopolymer mixture, wherein the expansive additive is selected from a group consisting of: vitreous calcium aluminosilicate, white silica fume, gray silica fume, and MgO.

46. The pumpable geopolymer composition of claim 23, further comprising:
ultrafine and submicron fillers comprising up to about 35 wt % of the geopolymer composition.

47. The pumpable geopolymer composition of claim 46, wherein the ultrafine and submicron fillers have a particle size of between 0.05 and 50 μm and are selected from a group consisting of: silica flour, ultrafine fly ash, silica fume, precipitated silica, micron alumina, zeolite, and clay particles.

48. The pumpable geopolymer composition of claim 23, further comprising:
ultrafine and submicron fillers comprising up to about 2 to about 25 wt % of the geopolymer composition.

49. The pumpable geopolymer composition of claim 48, wherein the ultrafine and submicron fillers have a particle size of between 0.05 and 50 μm and are selected from a group consisting of: silica flour, ultrafine fly ash, silica fume, precipitated silica, micron alumina, zeolite, and clay particles.

50. The pumpable geopolymer composition of claim 23, wherein mixing all solid ingredients of the geopolymer composition with the alkali silicate-free activator solution yields a pumpable geopolymer slurry with a room temperature viscosity of less than 5 Pa·s at a shear rate of 100 s⁻¹.

51. The pumpable geopolymer composition of claim 23, wherein mixing all solid ingredients of the geopolymer composition with the alkali silicate-free activator solution yields a pumpable geopolymer slurry with a room temperature viscosity of less than 500 mPa·s at a shear rate of 100 s⁻¹.

52. The pumpable geopolymer composition of claim 23, wherein mixing all solid ingredients of the geopolymer composition with the alkali silicate-free activator solution forms a pumpable geopolymer slurry having an available pumping time of greater than 6 hours and a set time of greater than 6 hours and less than 24 hours when curing at 50° C.

53. The pumpable geopolymer composition of claim 52, wherein the pumpable geopolymer slurry forms a hardened geopolymer slurry having a compressive strength greater than 300 psi after curing for 48 hours and 1000 psi after curing for 28 days.

54. A pumpable geopolymer composition comprising:
a less reactive aluminosilicate;
a more reactive aluminosilicate;
an alkaline low-silicate activator solution as carrier fluid; and
a powdered alkali silicate glass.

55. The pumpable geopolymer composition of claim 54, wherein the less reactive aluminosilicate is selected from a group consisting of: Class F fly ash, pumice, volcanic ash, and ground perlite.

56. The pumpable geopolymer composition of claim 54, wherein the less reactive aluminosilicate is Class F fly ash with CaO less than or equal to 15%.

57. The pumpable geopolymer composition of claim 54, wherein the less reactive aluminosilicate is Class F fly ash with CaO less than or equal to 8%.

58. The pumpable geopolymer composition of claim 54, wherein the more reactive aluminosilicate is selected from a group consisting of: ground granulated blast furnace slag, Class C fly ash, metakaolin, vitreous calcium aluminosilicate, and kiln dust.

59. The pumpable geopolymer composition of claim 54, wherein the more reactive aluminosilicate is ground granulated blast furnace slag.

60. The pumpable geopolymer composition of claim 54, wherein a mass ratio of Class F fly ash to blast furnace slag ranges from about 0.99:0.01 to about 0.70:0.30.

61. The pumpable geopolymer composition of claim 54, wherein a mass ratio of Class F fly ash to blast furnace slag ranges from about 0.92:0.08 to about 0.85:0.15.

62. The pumpable geopolymer composition of claim 54, wherein the alkaline low-silicate activator solution contains alkali silicate and alkali hydroxide and water.

63. The pumpable geopolymer composition of claim 62, wherein the alkali silicate is selected from a group consisting of: potassium silicate and sodium silicate, wherein the alkali hydroxide is selected from a group consisting of: sodium hydroxide, potassium hydroxide and lithium hydroxide.

64. The pumpable geopolymer composition of claim 54, wherein the alkaline low-silicate activator solution has a molar ratio of SiO₂/M₂O less than about 0.50, M representing K, Na or Li.

65. The pumpable geopolymer composition of claim 54, wherein the alkaline low-silicate activator solution has a molar ratio of SiO₂/M₂O less than about 0.25, M representing K, Na or Li.

66. The pumpable geopolymer composition of claim 54, wherein the powdered alkali silicate glass is either a sodium silicate glass with a molar ratio of SiO₂/Na₂O from about 2.0 to about 3.6 or a potassium silicate glass with a molar ratio of SiO₂/K₂O from about 1.8 to about 3.0.

67. The pumpable geopolymer composition of claim 54, wherein the powdered alkali silicate glass has a particle size passing 100.

68. The pumpable geopolymer composition of claim 54, wherein the powdered alkali silicate glass has a particle size passing 200 mesh.

69. The pumpable geopolymer composition of claim 54, wherein a molar MOH calculated from a combination of the alkaline low-silicate solution and the powdered alkali silicate glass is less than about 10, M representing K, Na, Li.

70. The pumpable geopolymer composition of claim 54, wherein a molar MOH calculated from a combination of the alkaline low-silicate solution and the powdered alkali silicate glass is less than about 8, M representing K, Na, Li.

71. The pumpable geopolymer composition of claim 54, wherein a molar ratio of SiO₂/M₂O calculated from a combination of the alkaline low-silicate and the powdered alkali silicate glass is from about 0.25 to about 1.50, M representing K, Na or Li.

72. The pumpable geopolymer composition of claim 54, wherein a molar ratio of SiO₂/M₂O calculated from a combination of the alkaline low-silicate and the powdered alkali silicate glass is from about 0.40 to about 1.25, M representing K, Na or Li.

73. The pumpable geopolymer composition of claim 54, having a water to binder ratio from about 0.28 to about 0.55.

74. The pumpable geopolymer composition of claim 54, having a water to binder ratio from about 0.35 to about 0.45.

75. The pumpable geopolymer composition of claim 54, further comprising:
a superplasticizer from about 0.05% to about 1% as solids by weight of a binder, wherein the superplasctizer is selected from a group consisting of lignosulphonate derivative, naphthalene-based compound, melamine-based material, and polycarboxylate superplasticizing admixture.

76. The pumpable geopolymer composition of claim 54, further comprising:
one or more expansive additives comprising up to about 10% of the geopolymer composition and wherein the one or more expansive additives is selected from a group consisting of: vitreous calcium aluminosilicate, white silica fume, gray silica fume, and MgO.

77. The pumpable geopolymer composition of claim 54, further comprising:
one or more expansive additives comprising up to about 5% of the geopolymer composition and wherein the one or more expansive additives is selected from a group consisting of: vitreous calcium aluminosilicate, white silica fume, gray silica fume, and MgO.

78. The pumpable geopolymer composition of claim 54, further comprising:
ultrafine and submicron fillers, comprising up to about 35 wt % of the geopolymer composition.

79. The pumpable geopolymer composition of claim 78, wherein the ultrafine and submicron fillers have a particle size of between 0.05 and 50 μm and is selected from a group consisting of: silica flour, ultrafine fly ash, silica fume, precipitated silica, micron alumina, zeolite, and clay particles.

80. The pumpable geopolymer composition of claim 54, further comprising:
ultrafine and submicron fillers, comprising from about 2 to about 25 wt % of the geopolymer composition.

81. The pumpable geopolymer composition of claim 80, wherein the ultrafine and submicron fillers have a particle size of between 0.05 and 50 μm and is selected from a group consisting of: silica flour, ultrafine fly ash, silica fume, precipitated silica, micron alumina, zeolite, and clay particles.

82. The pumpable geopolymer composition of claim 54, wherein mixing all solid ingredients of the geopolymer composition with the alkaline low-silicate activator solution yields a pumpable geopolymer slurry with a room temperature viscosity of less than 5 Pa·s at a shear rate of 100 s⁻¹.

83. The pumpable geopolymer composition of claim 54, wherein mixing all solid ingredients of the geopolymer composition with the alkaline low-silicate activator solution yields a pumpable geopolymer slurry with a room temperature viscosity of less than 500 mPa·s at a shear rate of 100 s⁻¹.

84. The pumpable geopolymer composition of claim 54, wherein mixing all solid ingredients of the geopolymer composition with the activator low-solution forms a pumpable geopolymer slurry with an available pumping time of greater than 6 hours and a set time of greater than 6 hours and less than 24 hours when curing at 50° C.

85. The pumpable geopolymer composition of claim 84, wherein the pumpable geopolymer slurry forms a hardened geopolymer slurry having a compressive strength greater than 300 psi after curing for 48 hours and 1000 psi after curing for 28 days.
